(19) United States
(12) Patent Application Publication
(10) Pub. No.: US 2016/0173565 A1
(43) Pub. Date: Jun. 16, 2016

(54) METHOD AND SYSTEM FOR TIME-RELEASE E-BOOK GIFTING AND INTERFACE THEREFOR

(71) Applicant: Kobo Incorporated, Toronto (CA)

(72) Inventor: Sarah FLAWN, Toronto (CA)

(73) Assignee: KOBO INCORPORATED, Toronto, ON (CA)

(21) Appl. No.: 14/570,917

(22) Filed: Dec. 15, 2014

(51) Int. Cl. H04L 29/08; G06F 3/0488; G06Q 20/12; G06F 3/0484; G06F 3/0481

(52) U.S. Cl. CPC H04L 67/06; G06F 3/04842; G06F 3/04817; H04L 67/1078; G06Q 20/1235; G06F 3/0488

(57) ABSTRACT

A method and system for time-release-based gifting of an e-book including an interface for presentation at a recipient display device. The method includes receiving, from a sender account, a request for a gift dispatch, the request specifying at least the e-book, a recipient account, and an appointment date; dispatching a first indicium of the e-book to the recipient account, the recipient account associated with a recipient e-library of e-books viewable within a recipient e-library view at a recipient display device; during a lapse of time prior to the future appointment date, enabling viewing of the first indicium of the e-book within the recipient e-library view at the recipient display device; upon reaching the appointment date, downloading the e-book to a memory of the recipient display device; and replacing the first indicium with a second indicium of the e-book at the recipient display device, the second indicium comprising a graphical icon of the downloaded e-book within the recipient e-library view, the graphical icon showing at least a book title.

### TECHNICAL FIELD

Examples described herein relate to a system and method for e-book gifting.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation of a time-release-based e-book gifting scheme, in an embodiment.

FIG. 2 illustrates a schematic architecture of a computing device for configuring and launching a time-release-based e-book gifting scheme, according to an embodiment.

FIGS. 3a and 3b illustrate example embodiments for operation in configuring and deploying a time-release-based e-book gifting scheme.

FIG. 4 illustrates a method for operation in for configuring and using a time-release-based e-book gifting scheme, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

While conventional physical paper books typically include a fixedly-configured table of contents page(s) intended to assist a user or observer to locate a desired portion or page of the book for reading, a digitally rendered e-book may be configured in other, more fluid arrangements that allow alternative ways for a user to conveniently access a particular content portion or page of the e-book.

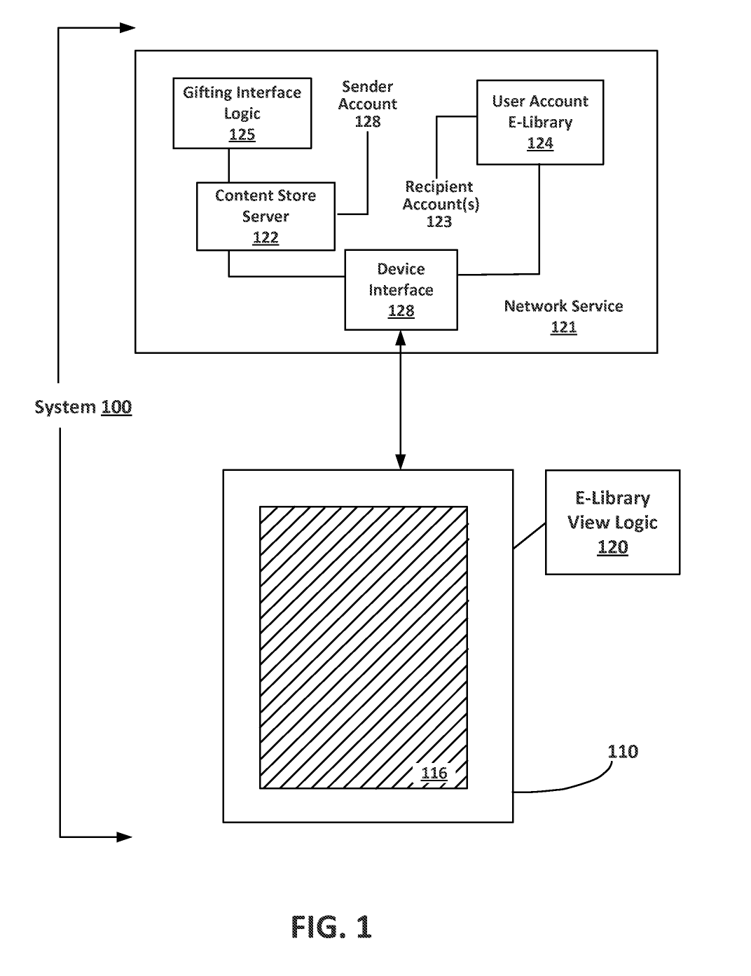

FIG. 1 illustrates a system 100 for utilizing applications and providing e-book services on a computing device configured for operation of a time-release-based e-book gifting scheme, according to an embodiment. In an example of FIG. 1, system 100 includes an electronic personal display device, shown by way of example as a recipient e-reading device 110, and a network service 121. The network service 121 can include multiple servers and other computing resources that provide various services in connection with one or more applications that are installed on the recipient e-reading device 110. By way of example, in one implementation, the network service 121 can provide e-book services that communicate with the recipient e-reading device 110. The e-book services provided through network service 121 can, for example, include services in which e-books are sold, shared, downloaded and/or stored. More generally, the network service 121 can provide various other content services, including content rendering services (e.g., streaming media) or other network application environments or services.

The recipient e-reading device 110 can correspond to any electronic personal display device on which applications and application resources (e.g., e-books, media files, documents) can be rendered and consumed. For example, the recipient e-reading device 110 can correspond to a tablet or a telephony/messaging device (e.g., smart phone). In one implementation, for example, recipient e-reading device 110 can run an e-reader application that links the device to the network service 121 and enables e-books provided through the service to be viewed and consumed by way of e-reading. In another implementation, the recipient e-reading device 110 can run a media playback or streaming application that receives files or streaming data from the network service 121. By way of example, the recipient e-reading device 110 can be equipped with hardware and software to optimize certain application activities, such as reading electronic content (e.g., e-books). For example, the recipient e-reading device 110 can have a tablet-like form factor, although variations are possible. In some cases, the recipient e-reading device 110 can also have an E-ink display.

In additional detail, the network service 121 can include a device interface 128, a content store server 122, and a user account electronic library (e-library) 124 storing e-books or digital content items. In some embodiments, content store server 122 and user account e-library may be implemented via server computing devices, as well as a server cloud computing system. Content store server 122 may be an online store for purchasing of digital content items for download therefrom onto a resident memory of a recipient e-reading device 110 and/or user account e-library 124. In this regard, a sender account 128 may be established for purposes of purchasing e-books online on behalf of a recipient account 123 associated with a recipient user account library 124. User account e-library 124 associates the recipient e-reading device 110 with a recipient user having a recipient account 123. The recipient account 123 can also be associated with ownership of, and/or accessibility to, one or more digital content items stored in content store server 122. In one embodiment, the digital content items are e-books, and the content store server 122 is an online store having e-books for purchase or other licensed use. The device interface 128 can handle requests from the recipient e-reading device 110 with regard to services and functionality of the network service 121. The device interface 128 can utilize information provided with recipient user account 123 in order to enable services, such as purchasing and downloading of e-books into user account e-library 124, and determining what e-books and content items providable via content store server 122 are associated with, and accessible to, recipient user account 123. Additionally, the device interface 128 can provide the recipient e-reading device 110 with access to the on-line content store server 122. The device interface 128 can handle input to identify content items (e.g., e-books), and further to associate content items to recipient account 123 of the user e-library 124.

Yet further, content store server 122 and user account e-library 124 can retain metadata for individual accounts 123 to identify e-books or other digital content items that have been purchased or made available for consumption for a given recipient account. Thus, information relating to e-books within user account e-library 124 can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

The recipient e-reading device 110, interchangeably referred to as recipient display device 110 herein, may be associated with the recipient user account 123, and in fact multiple such recipient display devices may be associated with a same account. As described in greater detail below, recipient e-reading device 110 can locally store content items (e.g., e-books) that are purchased or otherwise made available to the user of the recipient e-reading device 110 as well as to archive, in user account 124, e-books and other digital content items that have been purchased for the recipient user account 123, but are not necessarily stored in local resident memory at recipient display device 110.

With reference to an example of FIG. 1, recipient e-reading device 110 can include a touchscreen display 116. In an embodiment, the display screen 116 is touch-sensitive, to process touch inputs including gestures (e.g., swipes). For example, the display screen 116 may be integrated with one or more touch sensors to provide a touch-sensing region on a surface of the display screen 116. For some embodiments, the one or more touch sensors may include capacitive sensors that can sense or detect a human body's capacitance as input. In the example of FIG. 1, the touch-sensing region coincides with a substantial surface area, if not all, of the display screen 116.

In some embodiments, the recipient e-reading device 110 includes features for providing functionality related to displaying paginated content, including paginated content comprising an e-magazine or e-comic book. The recipient e-reading device 110 can include page transitioning logic, which enables the user to transition through paginated content. The recipient e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic can operate to enable the user to transition from a given page state to another page state In the specific example embodiment where a given page state coincides with a single page, for instance, each page state corresponding to one page of the digitally constructed, ordered sequence of pages paginated to comprise, in one embodiment, an e-book. In some implementations, the page transitioning logic enables single page transitions, chapter transitions, or cluster transitions (multiple pages at one time).

According to some embodiments, the recipient e-reading device 110 includes display sensor logic to detect and interpret user input or user input commands made through interaction with the touch sensors. By way of example, display sensor logic can detect a user making contact with the touch-sensing region of the display screen 116, otherwise known as a touch event. More specifically, display sensor logic can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state of display 116.

E-library view (or interface) logic 120 provides an interface, displayable via display screen 116 of recipient display device 110, showing titles in a user's e-library collection of e-books, or from a user's home page in relation to an online content store server 122 hosting e-books for commercial sale and downloading therefrom. The e-library collection of e-books may be hosted via a remotely located computer server device associate with user account e-library 124, or at a locally resident within a memory at recipient display device 110. The e-library view logic 120 can display iconic or other graphic representations of individual e-books in the user's e-library collection. For example, the e-library view logic 120 can use the metadata associated with the records of the e-books in the user's e-library account 124 to display lists, folders, or other virtual structures that include graphic representations and/or other identifiers of e-books in the user's collection. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information. The user's collection can include e-books that the user has on the particular device 110 (e.g., locally stored e-books), as well as e-books that are not locally stored, but rather are stored or archived at a remote computer server and associated with the user account e-library 124.

Gifting interface logic 125, residing at content store server 122 in an embodiment, may optionally be implemented as a software module comprising instructions stored in memory 250 of recipient display device 110. Gifting interface logic module 125 in conjunction with e-library view logic 120 provides depictions of the e-book gift via graphical icon representations at display screen 116 of recipient display device 110, the depictions varying depending on progress or lapse of time relative to an appointment date.

E-library view logic module 120 and gifting interface logic module 125 can be implemented as software modules comprising instructions stored in a memory of a computing device, such as content store server 122 and/or recipient display device 110. In one or more embodiments of e-library view logic module 120, and gifting interface logic module 125 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of e-library view logic module 120 and gifting interface logic module 125 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

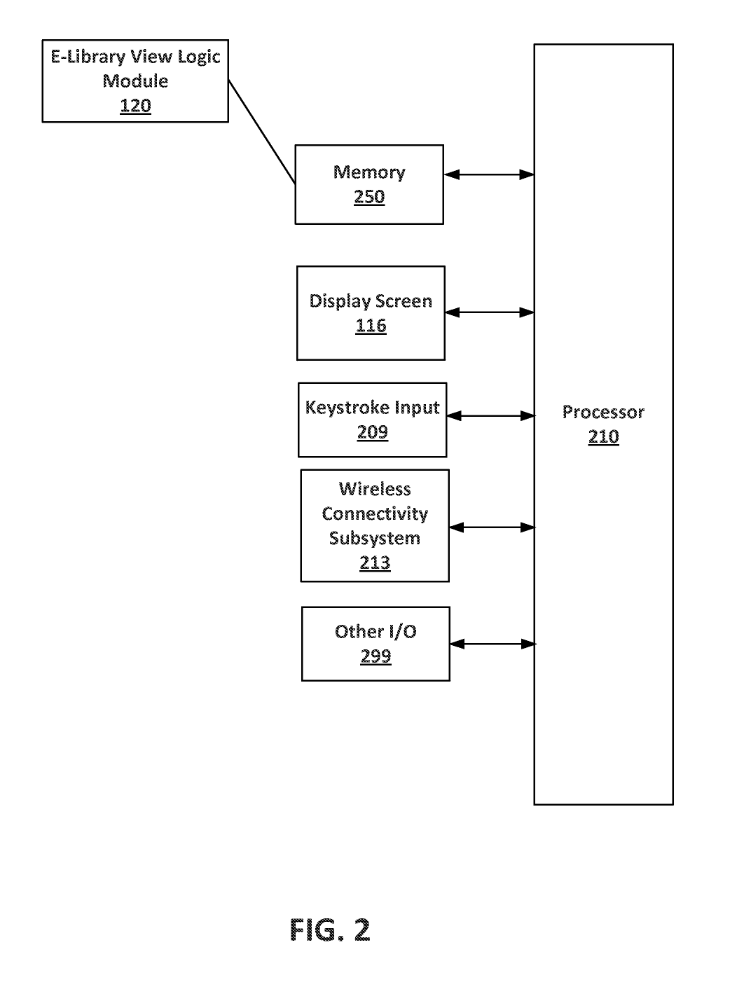

FIG. 2 illustrates a schematic architecture of a recipient computing device for configuring a time-release-based e-book gifting scheme, according to an embodiment.

Recipient e-reading device 110 further includes processor 210, a memory 250 storing instructions and logic pertaining at least to display sensor logic, e-library view logic module 120 and optionally, gifting interface logic module 125 as described in regard to an embodiment of content store server 122.

Processor 210 can implement functionality using the logic and instructions stored in memory 250. Additionally, in some implementations, processor 210 communicates with the network service 121 (see FIG. 1). More specifically, the recipient e-reading device 110 can access the network service 121 to receive various kinds of resources (e.g., digital content items such as e-books, configuration files, account information), as well as to provide information (e.g., user account information, service requests etc.). For example, recipient e-reading device 110 can receive application resources, such as e-books or media files, that the user elects to purchase or otherwise download via the network service 121. The application resources that are downloaded onto the recipient e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

Recipient e-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which recipient display device 110 is intended to operate, such as in accordance with Wi-Fi, Bluetooth, Near Field Communication (NFC) communication protocols, and the like.

E-library view logic module 120 can be implemented as a software module, comprising instructions stored in memory 250, on mobile recipient display device 110. In one implementation, the local memory 250 can include records for each e-book in the user's e-library account 124, each record include metadata of the e-books therein. The user may have the content portion of select e-books archived remotely at a computer server cloud system, so as not to reside in the local memory 250, but be provided by the network service 121 upon request or as needed. By way of example, the e-library view logic module 120 can display the e-books of a user's collection in the form of a virtual bookshelf or bookcase feature showing graphical icons representing the e-books. In such an implementation, the e-books are displayed as icons that include imagery, title information, etc. In a variation, the e-library view module 120 can display representations of e-books in the user's collection as icons, or as icons with associated text. Still further, folders can be used to provide a panel view of the graphic representations (e.g., icons and/or text) of the e-books in the user's e-library collection 124, corresponding to a side view of a bookshelf showing book spines with titles printed thereon for identifying individual books.

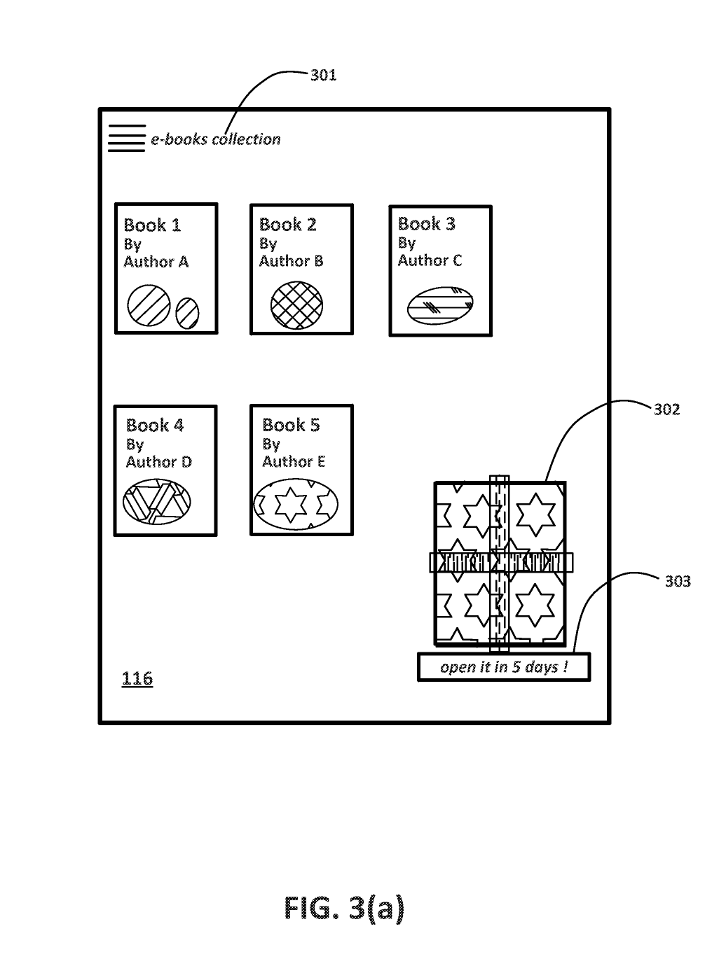

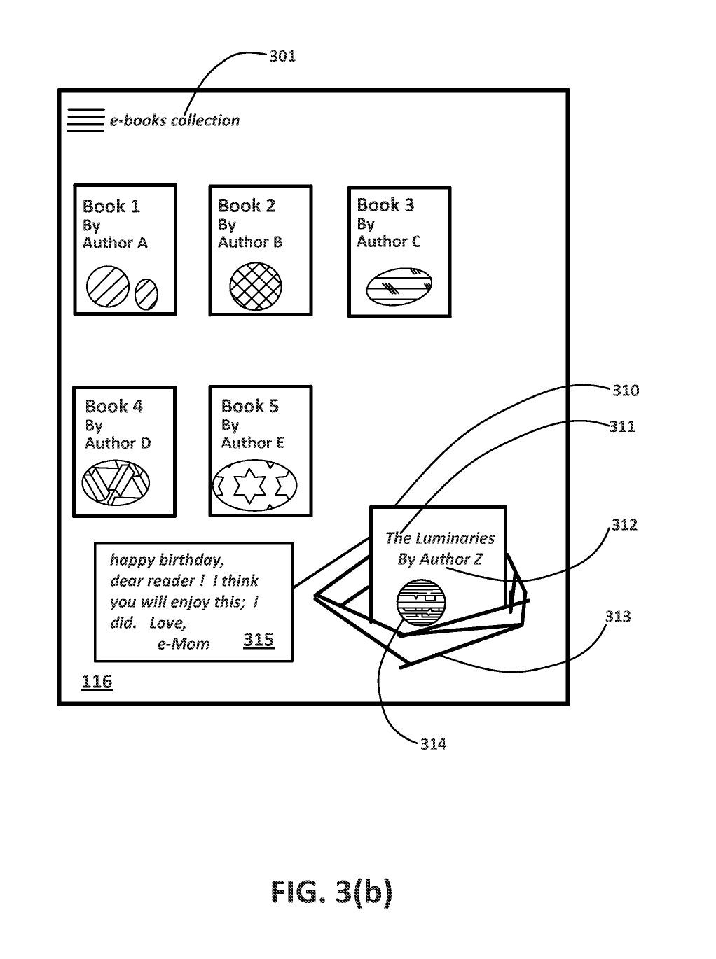

Gifting interface logic 125 of content store server 122 may optionally be implemented as a software module comprising instructions stored in memory 250 of recipient display device 110. Gifting interface logic module 125 in conjunction with e-library view logic 120 provides depictions of the e-book gift via graphical icon representations at display screen 116 of recipient display device 110, the depictions varying depending on progress or lapse of time until the appointment date is reached, as described further in regard to FIG. 3a and FIG. 3b.

FIGS. 3a and 3b illustrate example embodiments for operation in configuring and launching an e-book reading interface.

In prelude to the operations depicted in FIGS. 3a and 3b, a sender having access to online content store 122 via a sender account 128 in one embodiment, may prepare a request for a gift dispatch of an e-book to a recipient account 123 of user e-library account 124. The request may specify an email address of recipient account 123, the e-book to be gifted, an appointment date for time-based release of the e-book particulars, such as title and author, to the recipient account for viewing thereof, and a personalized message such as “happy birthday!” intended to memorialize a an occasion associated with gift. The term appointment date as used herein may include not only a date certain, but optionally a time of day at which the generalized e-book gift icon is to be “opened” and made available for viewing with particularity at display screen 116 of recipient e-reading device 110. Yet further, it is contemplated that the method and system described herein may be deployed for other digital content items besides e-books; in fact, for any digital content items which may be consumed upon being downloaded to a recipient device, including video or audio digital content items.

FIG. 3a illustrates a view of a user's e-library collection 301 (or a part thereof) of e-books as rendered in conjunction with e-library view logic 120, showing a generalized gift-wrapped e-book graphical icon 302 within display screen 116 of recipient display device 110. Gifting interface logic 125 operates in conjunction with recipient e-library viewing logic 120 to enable viewing of generalized gift-wrapped e-book graphical icon 302 within the recipient e-library view 301 at display screen 116 of recipient display device 110.

The generalized graphical icon 302 depiction at all times prior to the appointment date may not display particulars of the e-book being gifted, but rather draws the recipient's attention in a manner intended to build anticipation of opening the gift at the appointed time, such as via a countdown message 303 of days or time remaining until the e-book gift is available for opening. It is contemplated that during this period gift-wrapped e-book graphical icon 302 may be depicted using varying illumination levels, sizes, colors, and visual pulsations to draw a recipient's attention and build anticipation around the gift. In one embodiment, the gift-wrapped e-book graphical icon 302 as downloaded from online content store 122 does not include the e-book content, but rather the e-book content is made available for downloaded only at or after the appointment time. In another embodiment, the e-book content may be downloaded to user account e-library 124 and/or recipient device 110 with the gift-wrapped e-book graphical icon 302, but remains in a locked or unavailable state during lapse of time until the appointment date, whereupon the lock is released, the e-book content is made available for viewing with particularity (title, author, etc.) and for reading.

Upon lapse of time reaching the appointment date, FIG. 3b depicts a view at display screen 116 when the user enacts a touchscreen display selection event, such as a touch event. Gifting interface logic 125 operates in conjunction with recipient e-library viewing logic 120 to replace the gift-wrapped e-book graphical icon 302 with open gift e-book graphical icon 310 of the e-book at the recipient display device 110. Gifting interface logic module 120, in an embodiment, resides at content store server 122. Gift-wrapped e-book graphical icon 302 changes into, or is replaced by, open gift e-book graphical icon 310 within e-books collection 301 as rendered in conjunction with user account e-library 124 and e-library view logic 120. In embodiments, open gift e-book graphical icon 310 is displayed within partially-removed gift-wrapping 313, with e-book author name 312, title 311 and book artwork 314 from metadata of the e-book. Personalized occasion message 315 from sender is display at recipient display device 110 upon receiving the selection input action upon open gift e-book graphical icon 310. Launch of the e-book for reading may be triggered by a user enacting a touch event upon the open gift e-book graphical icon 310 among e-library collection 301 as rendered via e-library view logic 120 as displayed on display screen 116 via e-library view logic 120. In one embodiment, the personalized message of the sender to the recipient, as submitted by the sender in the request for gift dispatch, may be displayed on display screen 116, upon enactment of the touch event or other selection input at recipient e-reading device 110. In an alternate embodiment, and in lieu of launching for immediate reading, options may be provided for the recipient to place the gifted e-book into a “to be read later” queue, or even to discard the e-book from their e-library view or e-library account 124.

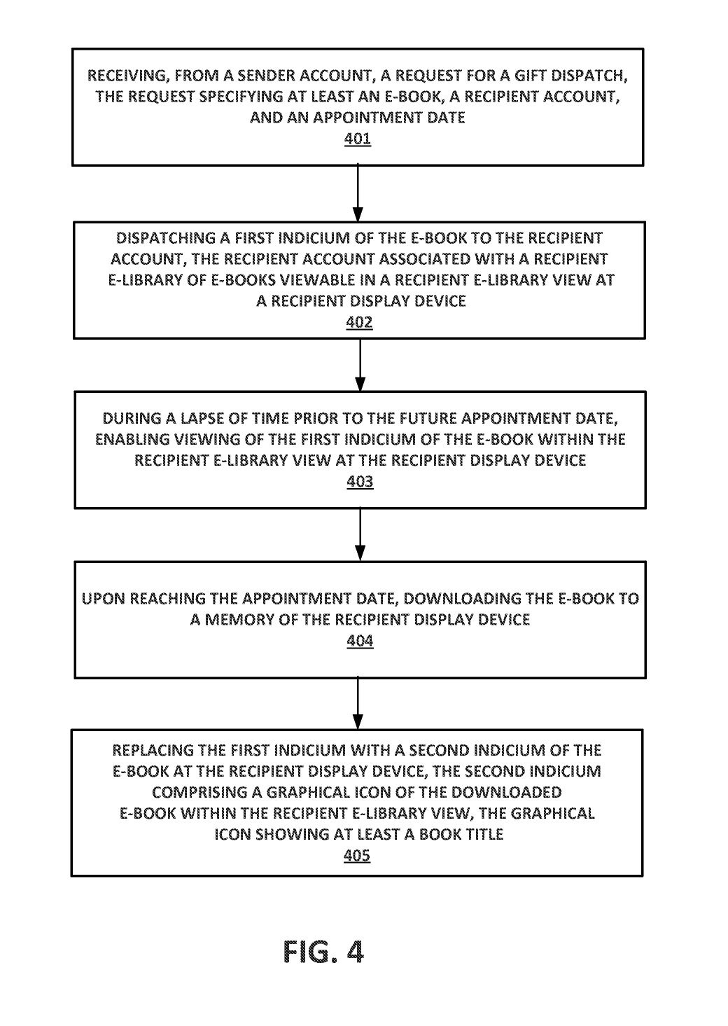

Next with reference to FIG. 4, illustrated is a method for operation in configuring and launching an e-book reading interface on a computer device having a touchscreen display, according to an embodiment. In describing the example of FIG. 4, reference will be made to components such as described with regard to FIGS. 1 through 3 for purposes of illustrating components for performing a step or sub-step as described.

At step 401, receiving, from a sender account, a request for a gift dispatch, the request specifying at least an e-book, a recipient account, and an appointment date.

At step 402, dispatching a first indicium of the e-book to the recipient account 123, the recipient account associated with a recipient e-library of e-books viewable in a recipient e-library view 120 at a recipient display device 110.

At step 403, during a lapse of time prior to the future appointment date, enabling viewing of the first indicium of the e-book within the recipient e-library view 120 at the recipient display device 110.

At step 404, upon reaching the appointment date, downloading the e-book to a memory 250 of the recipient display device 110.

At step 405, replacing the first indicium with a second indicium of the e-book at the recipient display device 110, the second indicium comprising a graphical icon of the downloaded e-book within the recipient e-library view, the graphical icon showing at least a book title. The replacing is controlled and triggered by gifting interface logic module 120, which in an embodiment, resides at content store server 122.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device including a memory storing instructions and an e-book, the method comprising:
receiving, from a sender account, a request for a gift dispatch, the request specifying at least the e-book, a recipient account, and an appointment date;
dispatching a first indicium of the e-book to the recipient account, the recipient account associated with a recipient e-library of e-books viewable within a recipient e-library view at a recipient display device;
during a lapse of time prior to the future appointment date, enabling viewing of the first indicium of the e-book within the recipient e-library view at the recipient display device;
upon reaching the appointment date, downloading the e-book to a memory of the recipient display device; and
replacing the first indicium with a second indicium of the e-book at the recipient display device, the second indicium comprising a graphical icon of the downloaded e-book within the recipient e-library view, the graphical icon showing at least a book title.

2. The method of claim 1 further comprising performing a selection action upon the graphical icon at the recipient computing device.

3. The method of claim 2 wherein the selection action is one of: launching the e-book content for reading at the display screen, postponing reading by relegating the e-book into a “to be read later” queue of the recipient e-library view, and discarding the e-book from the recipient e-library view.

4. The method of claim 1 wherein downloading the e-book comprises further downloading of content and metadata of the e-book.

5. The method of claim 4 wherein the graphical icon and the book title are at least partly derived from the metadata.

6. The method of claim 5 wherein the graphical icon comprises cover artwork and text sourced from the metadata and correspondingly rendered on an as-published physical book counterpart of the e-book.

7. The method of claim 1 wherein the recipient e-library is hosted at one of: a remotely located computer server device and the memory of the computing device.

8. The method of claim 2 wherein the selection input received at the recipient display device comprises a touch event enacted upon the graphical icon, and whereupon receiving the selection input, a sender message is displayed at the display screen.

9. The method of claim 1 wherein the first indicium changes during the time lapse according to one of: a display illumination level, a size, a color, and a pulsation aspect.

10. The method of claim 1 wherein the second indicium comprises imagery of a partially-removed gift-wrapper allowing viewing of the book title within the recipient e-library view.

11. A computer-readable medium that stores instructions and an e-book for a computing device, the computing device including a processor and a memory, the instructions being executable by the processor to cause the computing device to perform operations that include:
receiving, from a sender account, a request for a gift dispatch, the request specifying at least the e-book, a recipient account, and an appointment date;
dispatching a first indicium of the e-book to the recipient account, the recipient account associated with a recipient e-library of e-books viewable in a recipient e-library view at a recipient display device;
during a lapse of time prior to the future appointment date, enabling viewing of the first indicium of the e-book within the recipient e-library view at the recipient display device;
upon reaching the appointment date, downloading the e-book to a memory of the recipient display device; and
replacing the first indicium with a second indicium of the e-book at the recipient display device, the second indicium comprising a graphical icon of the downloaded e-book within the recipient e-library view, the graphical icon showing at least a book title.

12. A computing device comprising:
a memory that stores a set of instructions and an e-book;
a processor that access the instructions in memory, the processor further configured to:
receive, from a sender account, a request for a gift dispatch, the request specifying at least the e-book, a recipient account, and an appointment date;
dispatch a first indicium of the e-book to the recipient account, the recipient account associated with a recipient e-library of e-books viewable in a recipient e-library view at a recipient display device;
during a lapse of time prior to the future appointment date, enabling viewing of the first indicium of the e-book within the recipient e-library view at the recipient display device;
upon reaching the appointment date, download the e-book to a memory of the recipient display device; and
replace the first indicium with a second indicium of the e-book at the recipient display device, the second indicium comprising a graphical icon of the downloaded e-book within the recipient e-library view, the graphical icon showing at least a book title.

13. The computing device of claim 12 further comprising performing a selection action upon the graphical icon at the recipient computing device.

14. The computing device of claim 12 wherein the selection action is one of: launching the e-book content for reading at the display screen, postponing reading by relegating the e-book into a “to be read later” queue of the recipient e-library view, and discarding the e-book from the recipient e-library view.

15. The computing device of claim 12 wherein downloading the e-book comprises further downloading of content and metadata of the e-book.

16. The computing device of claim 15 wherein the graphical icon and the book title are at least partly derived from the metadata.

17. The computing device of claim 16 wherein the graphical icon comprises cover artwork and text sourced from the metadata and correspondingly rendered on an as-published physical book counterpart of the e-book.

18. The computing device of claim 12 wherein the recipient e-library is hosted at one of: a remotely located computer server device and the memory of the computing device.

19. The computing device of claim 13 wherein the selection input received at the recipient display device comprises a touch event enacted upon the graphical icon.

20. The computing device of claim 12 wherein the first indicium changes during the time lapse according to one of: a display illumination level, a size, a color, and a pulsation aspect.
